(19) United States
(12) Patent Application Publication
(10) Pub. No.: US 2025/0039607 A1
(43) Pub. Date: Jan. 30, 2025

(54) A SPEAKER SYSTEM

(71) Applicant: Stereofonics ApS, Helsingør (DK)

(72) Inventor: Lars Beck, Copenhagen (DK)

(73) Assignee: Stereofonics ApS, Helsingør (DK)

(21) Appl. No.: 18/833,672

(22) PCT Filed: Jan. 27, 2022
(86) PCT No.: PCT/EP2022/051909

§ 371 Date: Jul. 26, 2024

(51) Int. Cl. H04R 5/02; H04R 1/02; H04R 1/28; H04R 5/04

(52) U.S. Cl. CPC H04R 5/02; H04R 1/025; H04R 1/026; H04R 1/2834; H04R 5/04; H04R 2420/07

(57) ABSTRACT

A speaker system for stereoscopic sounds comprising a first loudspeaker and a second loudspeaker. The first loudspeaker comprising a first speaker cabinet part enclosing a first speaker unit for outputting sound, a wireless communications module for communicating with a mobile device such as a smartphone and/or said second loudspeaker. The first loudspeaker having a first shape defining a first cavity.

The present disclosure relates to a speaker system such as for stereoscopic sounds. Specifically, a speaker system that may be carried as a single unit by the user and separated into two loudspeakers with a speaker unit in each such that the two loudspeakers may be placed apart with a distance to each other such that the user may have a stereoscopic experience.

A loudspeaker is to be understood as the product itself constituted by a housing enclosing a speaker unit. The speaker unit being the component outputting sound, for example an electroacoustic transducer for converting an electric audio signal into a sound.

In the art it is known to provide a single unit by using magnets to hold two or more loudspeakers together. They may be carried as a single unit because of the magnet locking them together.

However, this may not be a very stable integral unit, because an external force may be greater than the magnetic force, and the external force may cause the two loudspeakers to separate accidentally.

A first aspect of the present disclosure is:

A speaker system such as for stereoscopic sounds, comprising:
a first loudspeaker and a second loudspeaker, said first or second loudspeaker comprising a wireless communications module for communicating with a mobile device such as a smartphone,
said first loudspeaker comprising
a first speaker cabinet part enclosing a first speaker unit for outputting sound,
a first housing part connected to said first speaker cabinet part,
said first loudspeaker having a first shape defining a first cavity,
said second loudspeaker comprising
a second speaker cabinet part enclosing a second speaker unit for outputting sound,
said second speaker cabinet part fitting in said first cavity such that said speaker system constituting a single unit or integral unit when transporting said speaker system in a transport state and a pair of stereo units for placing apart for playing stereoscopic sounds.

This may provide a mechanical interlocking, and it may improve the stability of the single unit when it is carried, i.e. for the two loudspeakers to be separated it is required that they are removed from each other in the fashion dictated by the shape.

A second aspect of the present disclosure is:

A loudspeaker comprising:
a first speaker cabinet part enclosing a speaker unit for outputting sound,
a first housing part connected to said first speaker cabinet part,
said first housing part comprising
a proximal end at said speaker cabinet part and a distal end facing said speaker cabinet part, and
a counterweight for counterbalancing with respect to the weight of said speaker unit,
   said loudspeaker comprising a balance point arranged between said counterweight and said speaker unit,
said balance point being lower than said speaker unit when said loudspeaker resting on a table.

The purpose of the balance point is a point where all of the weight of the loudspeaker is supported when the loudspeaker rests on the balance point, i.e. it is the lowest part of the loudspeaker when the loudspeaker is resting on a horizontal surface such as a table or a floor.

The loudspeaker may have a centerline extending from one end of the loudspeaker to the other. The centerline may define a shape of an open curve (an open curve being a curve where the beginning and end points are different). The open curve may have a shape of a half yin-yang symbol, i.e. a circle with a tail being stretched out from the circle.

When the speaker system is a single unit, the speaker system/single unit has a shape defining a closed curve, i.e. the periphery of the loudspeaker defines a closed curve.

The speaker cabinet part may have a diameter to accommodate a speaker unit.

The speaker cabinet part and the housing part/arm may constitute the overall housing/cabinet of the loudspeaker, and may be made of aluminum or plastic or any other appropriate material.

The loudspeaker may comprise a stand/foot such that the loudspeaker may stand on the stand. The stand may be of a different material than the arm or housing part, preferably a flexible material such as an elastic material such as a rubber or silicone material.

In the following specific examples according to aspects of the present disclosure will be explained in more detail with reference to the accompanying drawings. The present disclosure may, however, be embodied in different forms than depicted below, and should not be construed as limited to any examples set forth herein. Rather, any examples are provided so that the disclosure will be thorough and complete, and will fully convey the scope of the invention to those skilled in the art. Like reference numerals refer to like elements throughout. Like elements will, thus, not be described in detail with respect to the description of each figure.

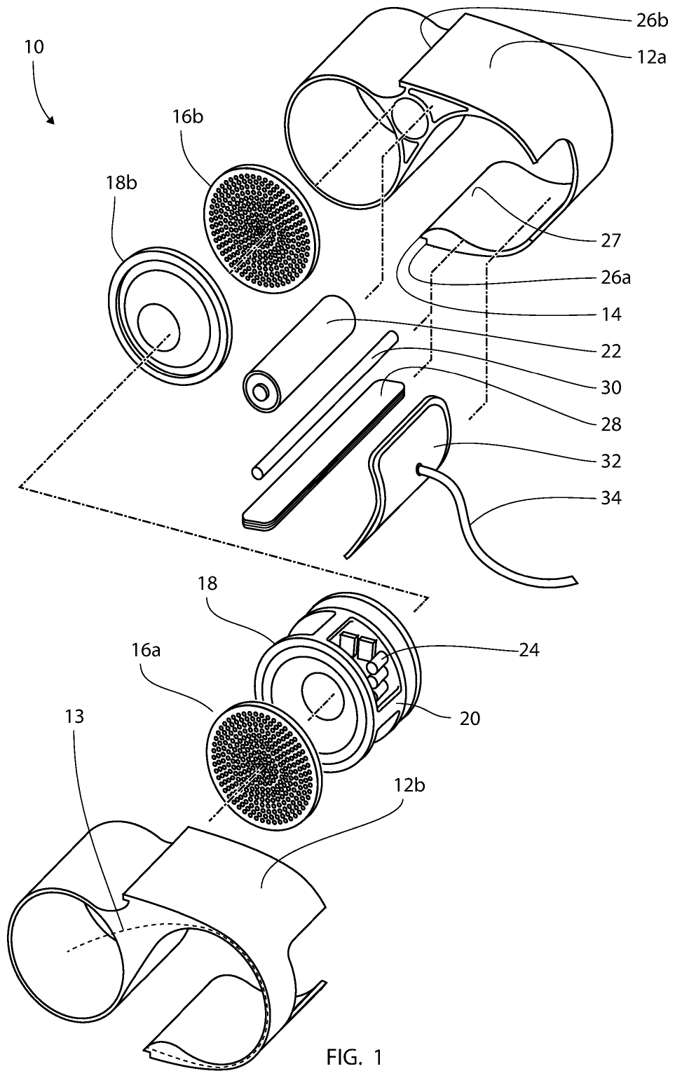

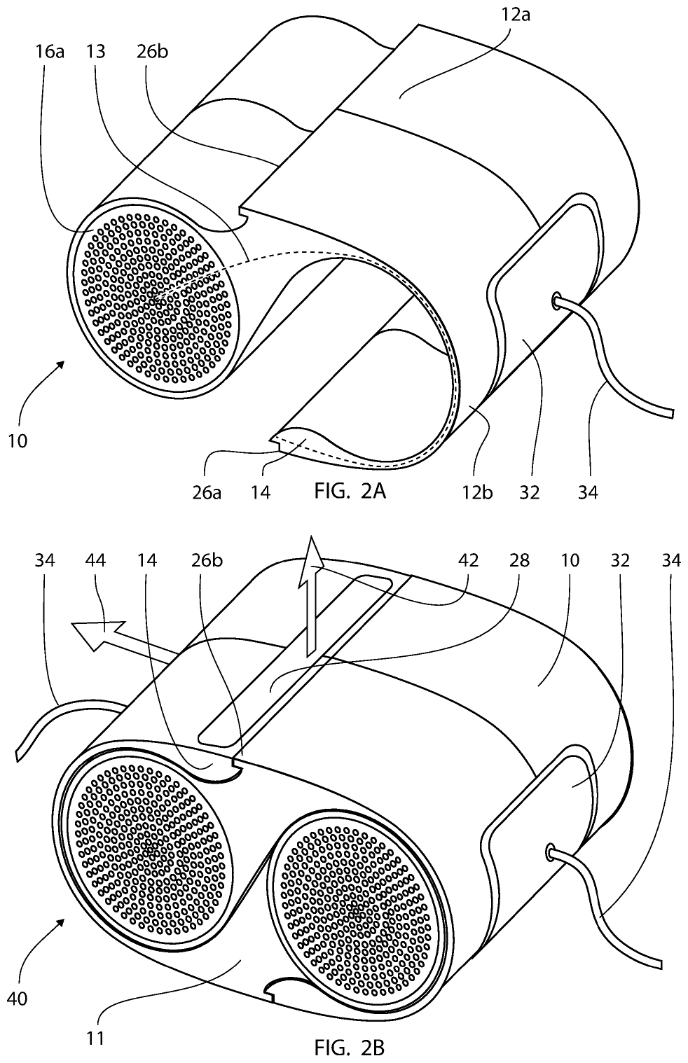

FIG. 1 illustrates an exploded view of a loudspeaker 10 and in FIG. 2a it is shown in assembled state.

The loudspeaker is illustrated with a loudspeaker cabinet divided in two halves (half-part ref. 12a and half-part ref. 12b). The two half-parts or shells are put together during assembly.

The loudspeaker cabinet is constituted by a part (speaker cabinet part) that encloses the speaker unit. It is illustrated as a cylinder. This is a shape that is suitable for housing a speaker while at the same time is an advantageous shape for fitting together with another loudspeaker. The cylinder axis is parallel with the speaker axis.

The speaker cabinet part is connected with a housing part for housing other components than the speaker—the speaker cabinet part goes over into the housing part.

The housing part is illustrated as an arm or projection that is U-shaped or hook-shaped or C-shaped, i.e. it extends from the speaker cabinet part and at its apex it turns around and goes back towards the speaker cabinet part.

The centerline is illustrated with the striped line, ref. 13.

The arm is illustrated as a free end 14, i.e. an end that is not connected to the speaker cabinet part. The shape/cavity defined by the arm is complement to the shape of the speaker cabinet part such that a speaker cabinet part fits in the cavity.

The speaker cabinet part may have a mesh at each end for transmitting sound there through, i.e. a first mesh 16a and a second mesh 16b.

At the front end (at ref. 16a) is a first diaphragm 18a connected to the speaker coil (not shown), which is supported by the chassis 20.

At the rear end (at ref. 16b) is a second diaphragm or cone 18b for sending sound out the rear end as well.

As an alternative, the rear end may be closed off (not having the second mesh and the cone) such that sound does not come out from the rear.

As another feature the side of the speaker cabinet part may have an opening (contemplated with a mesh in the opening and/or a cone) for letting sound out the side of the speaker cabinet part.

The side of the speaker cabinet part is to be understood as part of the cylinder wall making up the speaker cabinet part between the front end and rear end of the speaker cabinet part.

A battery 22 is illustrated within the housing part/arm, because the space defined by the speaker cabinet part may be to just accommodate the speaker unit and have no room for a battery. Location of a battery in the speaker cabinet part could mean that the round shape of the speaker cabinet part could not be used.

Electronic components 24 are illustrated inside the space defined by the speaker cabinet part, specifically at the chassis. Electronic components may be placed at a printed circuit boards elsewhere, for example next to the battery in the arm.

At the end of the arm may be located a first locking mechanism 26a which together with a second locking mechanism 26b at the proximal end of the arm forms an arrest for two loudspeakers when put together.

The first locking mechanism may be formed as a recess/notch in the arm. The second locking mechanism may be formed as a protrusion/flange.

The end of the arm may have a cross section that is wider than the part of the arm leading up to the end, i.e. in order to form a C-shape for gripping around a circular cylinder like the speaker cabinet part.

The shape or bulge 27 at the end of the free end together with the locking mechanisms is for encouraging the loudspeakers to be put apart in a direction parallel to the speaker cabinet axis.

At the end of the arm may be a foot/stand 28, which the loudspeaker rests on when placed on a horizontal surface. The foot may be made in a material that may absorb vibrations such as silicone or a rubber. The material being different than the material of the speaker cabinet part or arm. A logo may be placed at the foot.

Also placed at the end of the arm may be a magnet 30. The magnet may have different purposes: It may force two loudspeakers together for minimizing the risk that they slide apart, for example due to attraction to the battery in the other loudspeaker forming the loudspeaker pair (single unit). Alternative, a second magnet may be placed at the battery.

The magnet may also function as a switch, i.e. when the loudspeakers are separated from each other a change in magnetic field may activate a turn on and/or pairing routine for both speakers such that a user does not manually have to turn on both loudspeakers and manually pair the two loudspeakers to either a phone or each other.

A contact may also provide such functionality, i.e. the first loudspeaker may have a first contact and the second loudspeaker may have a second contact (not shown)—the contacts being in contact with each other when the two loudspeakers are together and when they are separated the contact is broken causing a turn on and/or pairing routine.

At the point of the arm furthest from the speaker cabinet part (at the apex of the arm) may be a counterweight 32. The counterweight is for counterweighing the weight of the speaker unit such that the loudspeaker may balance on the foot, i.e. the foot being the lowest point of the speaker when resting on a horizontal surface.

The counterweight may be of metal, and it may be configured as a mesh. It may be removably connected to the loudspeaker, i.e. it may be separated from the loudspeaker such that the loudspeaker weighs less.

A string 34 may be connected to the counterweight. The string may connect two loudspeakers for carrying the unit of two loudspeakers around the neck of a user for example.

FIG. 2b illustrates two loudspeakers (10 and 11) put together and forming a single unit 40.

The second loudspeaker may correspond to the first loudspeaker described in connection with FIG. 1.

The second loudspeaker has been turned 180 degrees compared to the first loudspeaker.

The first and second locking mechanisms prevent upwards movement of the arm of the second loudspeaker, i.e. movement in the direction opposite a horizontal surface that the single unit is resting on (upwards direction illustrated with the arrow 42).

The shape (bulge) of the free end 14 (together with the first and second locking mechanisms) prevent removing the second loudspeaker in a direction perpendicular to the axis of the speaker cabinet part (in a horizontal plane). Illustrated by the arrow 44.

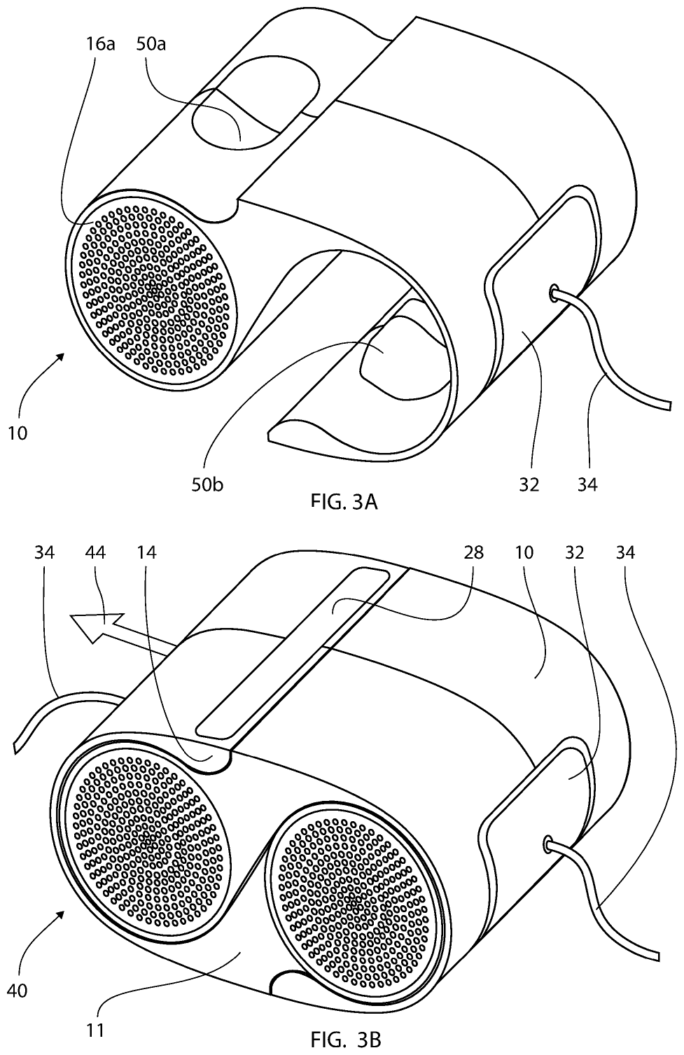

FIG. 3a illustrates a loudspeaker 10 as the one described in connection with FIG. 1, but with a different locking mechanism.

Specifically, the arm has no flange (at the proximal end of the arm) and no corresponding notch (at the distal end of the arm).

Instead the speaker cabinet part has an indentation or recess 50a shaped to match a protrusion 50b at the free end of the arm. These two features forming a snap-lock mechanism. The recess and protrusion may be switched around, i.e. the recess at the free end of the arm, and the protrusion at the speaker cabinet part.

FIG. 3b illustrates two loudspeakers (10, 11) with the snap-lock mechanism described in connection with FIG. 3a, and how they look as a single unit.

The arm may be of a flexible material such as an elastic material having a relaxed or equilibrium state. This may allow for the loudspeakers to be removed from each other/separated by moving the second loudspeaker in the perpendicular direction 44.

When the loudspeakers are separated, the arm is forced away from the equilibrium state, i.e. the free end 14 moves upwards. Internal forces in the arm is in that state forcing the arm towards its equilibrium state.

As the second loudspeaker has been moved away the arm returns to its equilibrium state.

Now follows a set of points, which constitute aspects of the present disclosure which may be considered independently patentable and as such the following sets form basis for possible future sets of claims:

1. A speaker system such as for stereoscopic sounds, comprising:
a first loudspeaker and a second loudspeaker, said first or second loudspeaker comprising a wireless communications module for communicating with a mobile device such as a smartphone,
said first loudspeaker comprising
a first speaker cabinet part enclosing a first speaker unit for outputting sound,
a first housing part connected to said first speaker cabinet part,
said first loudspeaker having a first shape defining a first cavity,
said second loudspeaker comprising
a second speaker cabinet part enclosing a second speaker unit for outputting sound,
said second speaker cabinet part fitting in said first cavity such that said speaker system constituting a single unit or integral unit when transporting said speaker system in a transport state and a pair of stereo units for placing apart for playing stereoscopic sounds.

2. A loudspeaker comprising:
a first speaker cabinet part enclosing a speaker unit for outputting sound,
a first housing part connected to said first speaker cabinet part,
said first housing part comprising
a proximal end at said speaker cabinet part and a distal end facing said speaker cabinet part, and
a counterweight for counterbalancing with respect to the weight of said speaker unit,
   said loudspeaker comprising a balance point arranged between said counterweight and said speaker unit,
said balance point being lower than said speaker unit when said loudspeaker resting on a table.

3. The speaker system according to any of the preceding items, said first housing part constituting a first arm, preferably being hook shaped or U-shaped or C-shaped, the distal end of said first arm preferably being a free end.

4. The speaker system according to any of the preceding items, said balance point arranged at said free end.

5. The speaker system according to any of the preceding items, the proximal end of said first housing part at said first speaker cabinet part being wider than the distal end of said first housing part.

6. The speaker system according to any of the preceding items, said first speaker cabinet part having a shape of a cylindrical geometry.

7. The speaker system according to any of the preceding items, said first speaker unit having a loudspeaker axis substantially parallel to the axis of said cylindrical geometry.

8. The speaker system according to any of the preceding items, said first housing part extending around said second speaker cabinet part for more than 180 degrees when said speaker system being in said transport state.

9. The speaker system according to any of the preceding items, said first loudspeaker comprising a stand.

10. The speaker system according to any of the preceding items, said first loudspeaker comprising a first battery, said first battery preferably arranged in said first housing part, preferably at the proximal end of said first housing part, preferably between said counterweight and said speaker unit, preferably closer to said balance point than said speaker unit or said counterweight (when seen in the plane of a surface supporting said loudspeaker on said stand).

11. The speaker system according to any of the preceding items, said first loudspeaker comprising a first membrane behind said first speaker unit, said first membrane preferably constituting a passive radiator.

12. The speaker system according to any of the preceding items, said first membrane defining a part of a speaker cabinet side wall dividing the inside from the outside of said first housing part.

13. The speaker system according to any of the preceding items, said second loudspeaker having a second wireless communications module for communicating with said mobile device or said first loudspeaker.

14. The speaker system according to any of the preceding items, said second loudspeaker comprising a second housing part connected to said second speaker cabinet part and constituting a second arm, preferably being hook shaped or U-shaped, the distal end of said second arm preferably being a free end.

15. The speaker system according to any of the preceding items, said first loudspeaker comprising a first magnet and said second loudspeaker preferably comprising a second magnet.

16. The speaker system according to any of the preceding items, said first magnet arranged adjacent said second magnet when said speaker system being in said transport state such that a magnetic force forcing said first loudspeaker together with said second loudspeaker.

17. The speaker system according to any of the preceding items, said first loudspeaker having a shape being substantially identical to the shape of said second loudspeaker.

18. The speaker system according to any of the preceding items, comprising a cord attached to said first loudspeaker and said second loudspeaker.

19. The speaker system according to any of the preceding items, said cord having a length such that when said cord being stretched, said first loudspeaker and said second loudspeaker having a distance between each other in the range of 70 to 110 cm such as 85 cm such that the user of said speaker system and said first loudspeaker and said second loudspeaker defining the corners of an equilateral triangle when the user of said speaker system being at an arms length to said speaker system.

20. The speaker system according to any of the preceding items, comprising a switch for switching said speaker system on when said first loudspeaker and said second loudspeaker being separated from said single unit.

21. The speaker system according to any of the preceding items, said second loudspeaker comprising a second battery.

22. The speaker system according to any of the preceding items, said first loudspeaker having a first coil and said second loudspeaker unit having a second coil for inductive charging of said second battery.

23. The speaker system according to any of the preceding items, said first loudspeaker comprising a first printed circuit board.

24. The speaker system according to any of the preceding items, said first loudspeaker comprising a microphone.

25. The speaker system according to any of the preceding items, said first loudspeaker comprising a camera.

26. The speaker system according to any of the preceding items, said first loudspeaker having a charging port for charging said battery of said first speaker unit.

The invention claimed is:

1. A speaker system such as for stereoscopic sounds, comprising:
a first loudspeaker and a second loudspeaker, the first loudspeaker or the second loudspeaker comprising a wireless communications module for communicating with a mobile device,
the first loudspeaker comprising:
a first speaker cabinet part enclosing a first speaker unit for outputting sound, and
a first housing part connected to said first speaker cabinet part,
the first loudspeaker having a first shape defining a first cavity, and
the second loudspeaker comprising a second speaker cabinet part enclosing a second speaker unit for outputting sound, the second speaker cabinet part fitting in the first cavity such that the speaker system constituting a single unit or integral unit when transporting the speaker system in a transport state and a pair of stereo units for placing apart for playing stereoscopic sounds.

2. The speaker system according to claim 1, the first housing part constituting a first arm, the first arm being hook shaped or U-shaped or C-shaped, the distal end of the first arm being a free end.

3. The speaker system according to claim 1, the balance point arranged at the free end.

4. The speaker system according to claim 1, the proximal end of the first housing part at the first speaker cabinet part being wider than the distal end of the first housing part.

5. The speaker system according to claim 1, the first speaker cabinet part having a shape of a cylindrical geometry.

6. The speaker system according to claim 1, the first speaker unit having a loudspeaker axis substantially parallel to the axis of the cylindrical geometry.

7. The speaker system according to claim 1, the first housing part extending around the second speaker cabinet part for more than 180 degrees when the speaker system being in the transport state.

8. The speaker system according to claim 1, the first loudspeaker comprising a stand.

9. The speaker system according to claim 1, the first loudspeaker comprising a first battery, the first battery arranged in the first housing part, at the proximal end of the first housing part, between the counterweight and the speaker unit, closer to the balance point than the speaker unit or the counterweight when viewed in a plane of a surface supporting the loudspeaker on the stand.

10. The speaker system according to claim 1, the first loudspeaker comprising a first membrane behind the first speaker unit, the first membrane constituting a passive radiator.

11. The speaker system according to claim 1, the first membrane defining a part of a speaker cabinet side wall dividing the inside from the outside of the first housing part.

12. The speaker system according to claim 1, the second loudspeaker having a second wireless communications module for communicating with the mobile device or the first loudspeaker.

13. The speaker system according to claim 1, the second loudspeaker comprising a second housing part connected to the second speaker cabinet part and constituting a second arm, being hook shaped or U-shaped, the distal end of the second arm being a free end.

14. The speaker system according to claim 1, the first loudspeaker comprising a first magnet and the second loudspeaker comprising a second magnet.

15. The speaker system according to claim 1, the first magnet arranged adjacent the second magnet when the speaker system being in the transport state such that a magnetic force forcing the first loudspeaker together with the second loudspeaker.
